(19) United States
(12) Patent Application Publication
(10) Pub. No.: US 2018/0234845 A1
(43) Pub. Date: Aug. 16, 2018

(54) MOBILE TERMINALS

(71) Applicants: BOE Technology Group Co., Ltd., Beijing (CN); Chengdu BOE Optoelectronics Technology Co., Ltd., Chengdu (CN)

(72) Inventors: Yuanjie Xu, Beijing (CN); Weiyun Huang, Beijing (CN); Shan Gao, Beijing (CN)

(21) Appl. No.: 15/705,494

(22) Filed: Sep. 15, 2017

(30) Foreign Application Priority Data
Feb. 15, 2017 (CN) 201710080813.X

(51) Int. Cl. H04W 12/06

(52) U.S. Cl. CPC H04W 12/06

(57) ABSTRACT

The present disclosure provides a mobile terminal, comprising: a frame on which one or more pressure sensing units are provided, wherein the one or more pressure sensing units are configured to instruct the mobile terminal to perform a corresponding operation when being pressed.

### CROSS-REFERENCE TO RELATED APPLICATION(S)

The present application claims priority to the Chinese Patent Application No. 201710080813.X, filed on Feb. 15, 2017, entitled “MOBILE TERMINALS,” which is incorporated herein by reference in its entirety.

### TECHNICAL FIELD

The present disclosure relates to the field of communication technology, and more particularly, to a mobile terminal.

### BACKEND

A conventional mobile terminal may comprise a frame on which physical keys which are partly protruded are provided, and a user may press the keys to achieve corresponding functions. However, only a few functions can be implemented by pressing a physical key. If more functions are required to be achieved, it needs to set more keys on the frame of the mobile terminal, which may take up more space on the frame and increase a thickness and a weight of the mobile terminal.

### SUMMARY

The present disclosure provides a mobile terminal, comprising:

a frame on which one or more pressure sensing units are provided,

wherein the one or more pressure sensing units are configured to, when at least one of the one or more pressure sensing units is pressed, instruct the mobile terminal to perform an operation associated with the pressed pressure sensing unit.

In an example, the pressure sensing units comprises a left frame pressure sensing unit and a right frame pressure sensing unit, and the mobile terminal is instructed to perform an unlock operation by pressing the left frame pressure sensing unit and the right frame pressure sensing unit.

In an example, the pressure sensing units further comprise an upper frame pressure sensing unit, and the mobile terminal is instructed to perform a lock screen operation by simultaneously pressing the left frame pressure sensing unit, the right frame pressure sensing unit and the upper frame pressure sensing unit.

In an example, the pressure sensing units further comprise a lower frame pressure sensing unit, and the mobile terminal is instructed to perform a home page return operation by simultaneously pressing the left frame pressure sensing unit, the right frame pressure sensing unit and the lower frame pressure sensing unit.

In an example, the pressure sensing units comprise a left frame pressure sensing unit and right frame pressure sensing units which comprise at least one of a first right frame pressure sensing unit, a second right frame pressure sensing unit and a third right frame pressure sensing unit, and the mobile terminal is instructed to perform an associated operation by pressing the left frame pressure sensing unit and any of the right frame pressure sensing units.

In an example, the mobile terminal is instructed to perform a screen wake-up operation by pressing the left frame pressure sensing unit and the first right frame pressure sensing unit.

In an example, the mobile terminal is instructed to perform a dialing operation by pressing the left frame pressure sensing unit and the second right frame pressure sensing unit.

In an example, the mobile terminal is instructed to perform a photographing operation by pressing the left frame pressure sensing unit and the third right frame pressure sensing unit.

In an example, the mobile terminal further comprises a controller, wherein the pressure sensing units are pressure sensors, wherein each of the pressure sensors is connected to the controller and configured to, upon receiving a pressing operation, generate a corresponding pressing signal and transmit the pressing signal to the controller.

In an example, the mobile terminal further comprises a controller, wherein the pressure sensing units are capacitor electrodes, wherein each of the capacitor electrodes is connected to the controller and configured to, upon receiving a pressing operation, generate a corresponding capacitance signal and transmit the capacitance signal to the controller.

### BRIEF DESCRIPTION OF THE DRAWINGS

FIG. 1 shows a diagram of a conventional mobile terminal;

FIG. 2 illustrates a diagram of a mobile terminal according to the present disclosure;

FIGS. 3A-3E illustrate a diagram of connection of pressure sensing units according to the present disclosure; and

FIGS. 4A-4E illustrate a diagram of operations of a mobile terminal according to the present disclosure.

### DETAILED DESCRIPTION

The present disclosure will be described in further detail below in conjunction with the accompanying drawings and specific embodiments.

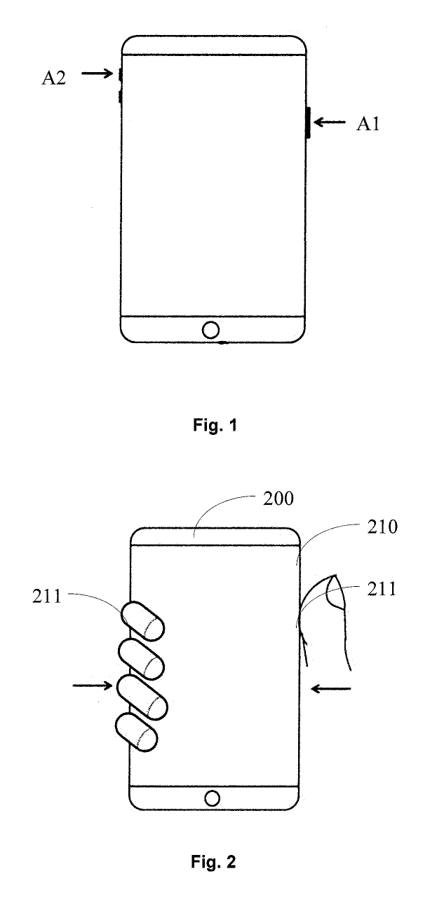

FIG. 1 is a diagram of a conventional mobile terminal. As shown in FIG. 1, A1 is the power key, and A2 is a volume adjustment key. The mobile terminal may be powered on or powered off or a screen of the mobile terminal may be unlocked or locked by pressing the power key A1, and a volume of the mobile terminal may be adjusted by pressing the volume adjustment key A2 etc.

FIG. 2 illustrates a diagram of a mobile terminal according to the present disclosure. As shown in FIG. 2, the mobile terminal 200 according to the present disclosure has a frame 210 on which one or more pressure sensing units 211 are provided. The one or more pressure sensing units 211 are configured to, when at least one of the one or more pressure sensing units 211 is pressed, instruct the mobile terminal 200 to perform an operation associated with the pressed pressure sensing unit.

In the present disclosure, the mobile terminal 200 may be an electronic device such as a mobile terminal, a tablet computer, an intelligent watch, an electronic reader, etc., and a specific type of the mobile terminal 200 is not limited in the present disclosure.

In general, the mobile terminal 200 may comprise the frame 210. The frame 210 may be of a metallic material such as aluminum alloy or stainless steel, or may also be a plastic material such as polycarbonate, etc., and a type of the material used for the frame 210 is not limited in the present disclosure.

According to the present disclosure, the frame 210 may be further provided with one or more pressure sensing units 211 for sensing a pressing operation of a user. Specifically, the one or more pressure sensing units 211 may be provided on an outer surface of the frame 210 or may be provided on an inner side of the frame 210.Those skilled in the art may determine how to set the pressure sensing units 211 according to a specific type of the pressure sensing units 211, which is not limited in the embodiments of the present disclosure.

For example, the user instructs the mobile terminal 200 to perform an operation associated with pressed pressure sensing units by pressing the pressure sensing units 211 at different locations on the frame 210. For example, the user may simultaneously press pressure sensing units 211 on the left side and right side of the frame (which will be referred to as a left frame pressure sensing unit 211 and a right frame pressure sensing unit 211), and a controller of the mobile terminal completes an unlock operation for the mobile terminal 200 upon receiving signals generated by the pressing. Of course, those skilled in the art may also determine a correspondence relationship between pressure sensing units at different locations or different combinations of the pressure sensing units and corresponding operations according to practical requirements, which is not limited in the embodiments of the present disclosure.

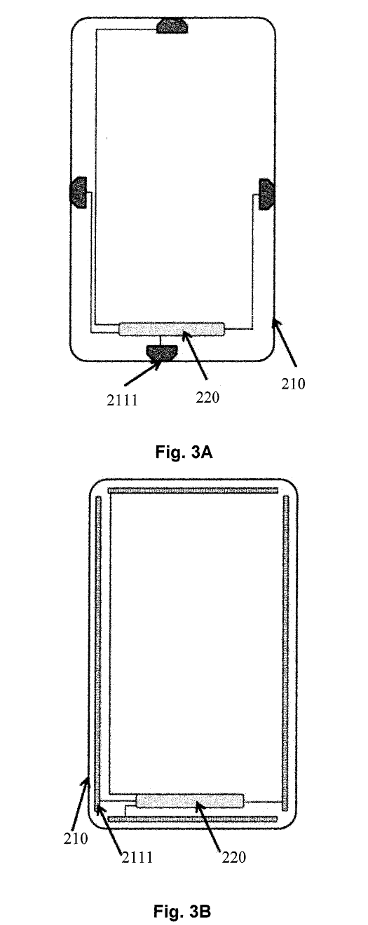

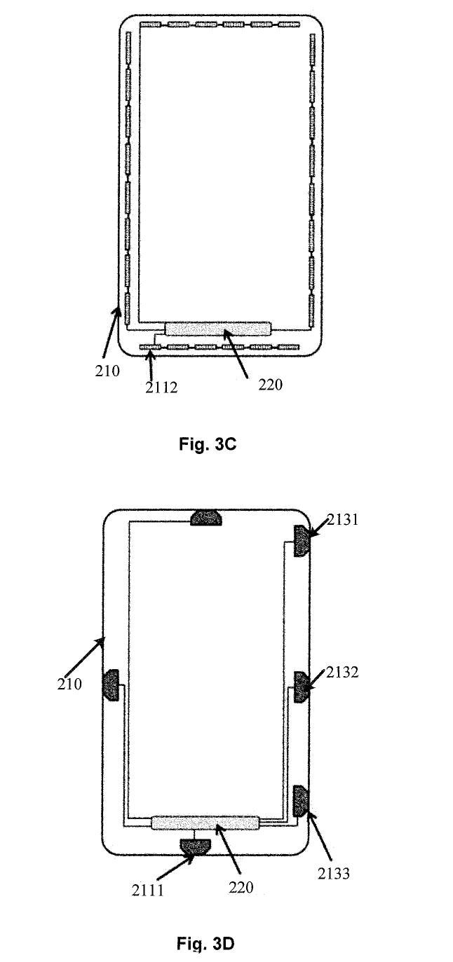

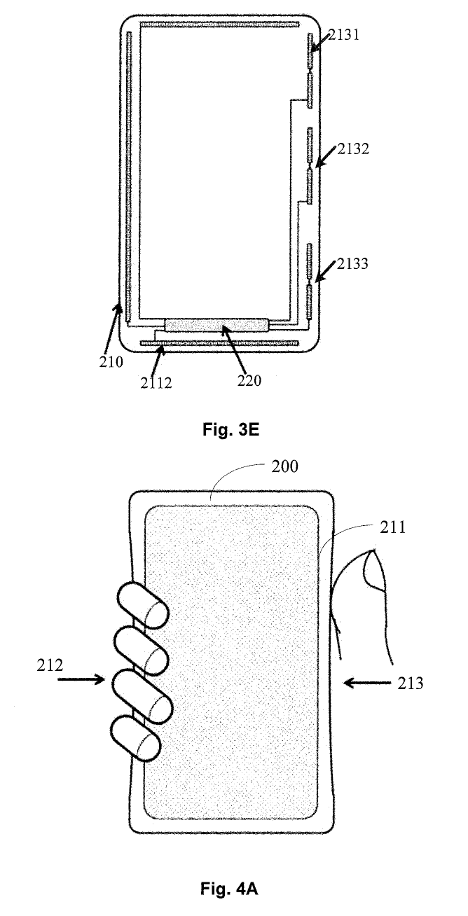

FIG. 3A illustrates a diagram of connection of the pressure sensing units 211 according to the present disclosure. For example, the pressure sensing units 211 in FIG. 3A may be pressure sensors 2111. Each of the pressure sensors 2111 is connected to the controller 220, and maybe used to generate a corresponding pressing signal and transmit the pressing signal to the controller 220 upon receiving pressing operation to instruct the mobile terminal 200 to perform an associated operation.

FIG. 3B illustrates another diagram of connection of the pressure sensing units 211 according to the present disclosure. For example, the pressure sensing units 211 in FIG. 3B may be capacitor electrodes 2112. Similarly to the pressure sensors 2111, each of the capacitor electrodes 2112 may be connected to the controller 220, and may be used to generate a corresponding capacitance signal and transmit the capacitance signal to the controller 220 upon receiving a pressing operation to instruct the mobile terminal 200 to perform an associated operation. For example, after the capacitor electrodes 2112 are provided on the frame 210 of the mobile terminal 200, capacitance is formed between the capacitor electrodes 2112 and the frame 210. When the frame is under pressure, distances between the frame210 and the capacitor electrodes 2112 are changed, so that the capacitance is changed accordingly, and a variation in the capacitance signal is transmitted to the controller 220 through, for example, a signal line.

FIG. 3C illustrates yet another diagram of connection of the pressure sensing units 211 according to the present disclosure. In contrast to the arrangement of the electrodes in FIG. 3B, the electrodes of the frame 210 are arranged as a plurality of interconnected small electrode portions in FIG. 3C, and the present disclosure is not limited thereto.

Those skilled in the art may also select other means as the pressure sensing units 211 for sensing a pressing operation of a user according to practical requirements, and the present disclosure is not limited thereto.

For ease of understanding, the mobile terminal 200 according to the present disclosure will be described below.

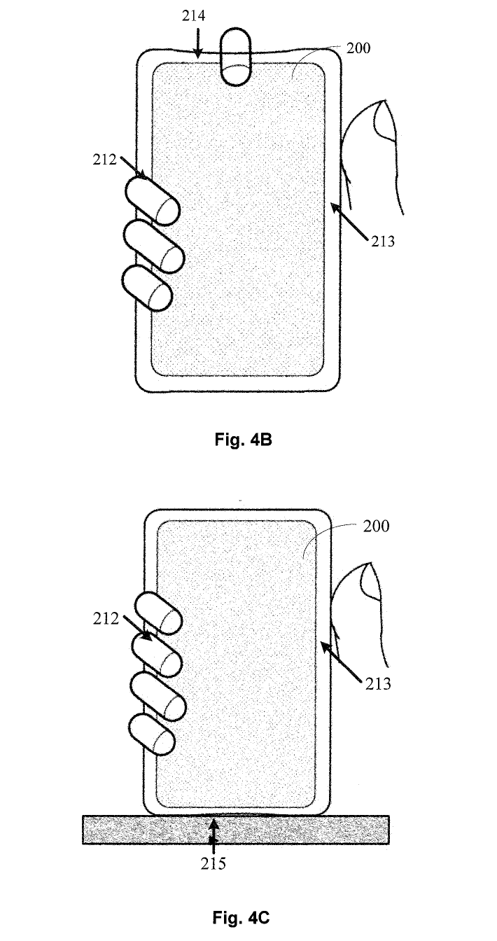

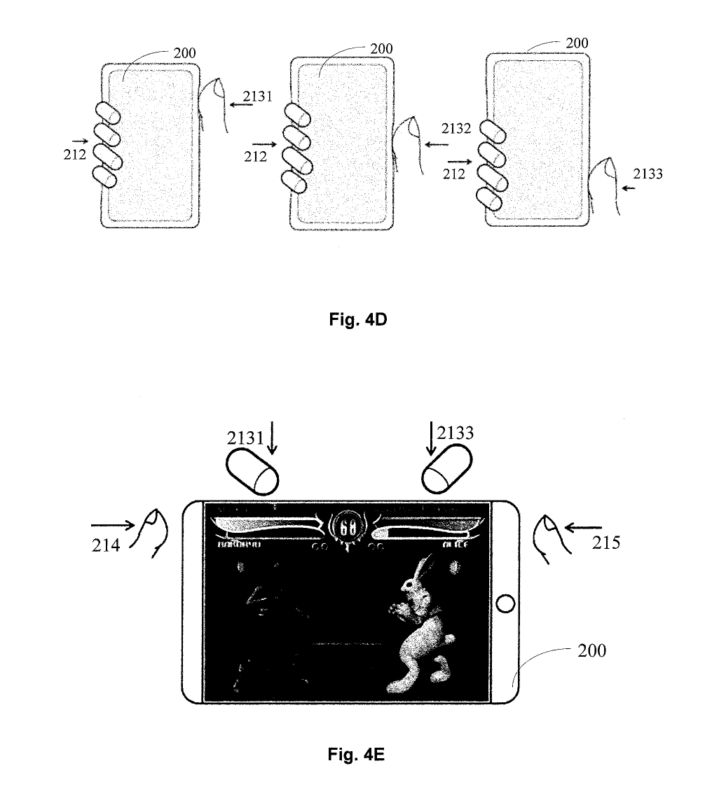

FIG. 4A illustrates a diagram of operations of the mobile terminal 200 according to the present disclosure. As shown in FIG. 4A, the pressure sensing units 211 may further comprise a left frame pressure sensing unit 212 and a right frame pressure sensing unit 213, and a user may instruct the mobile terminal 200 to perform an unlock operation by pressing the left frame pressure sensing unit 212 and the right frame pressure sensing unit 213.

In order to prevent the mobile terminal from being mis-operated in a dormant state, the mobile terminal may be brought into a locked state after a preset time, and may continue to operate only after it is unlocked. Therefore, according to the present disclosure, the user may complete unlocking of the mobile terminal 200 by pressing the left frame pressure sensing unit 212 and the right frame pressure sensing unit 213 of the mobile terminal 200. Specifically, when the user holds the mobile terminal 200, the user may touch the left side and the right side of the frame of the mobile terminal 200 with palms or fingers so that the left frame pressure sensing unit 212 and the right frame pressure sensing unit 213 may simultaneously generate corresponding pressing signals. The controller 220 (not shown in FIG. 4A) of the mobile terminal 200 may perform an unlock operation for the mobile terminal 200 after sensing the pressing signals.

FIG. 4B illustrates another diagram of operations of the mobile terminal 200 according to the present disclosure. As shown in FIG. 4B, the pressure sensing units 211 may further comprise an upper frame pressure sensing unit 214, and the user may instruct the mobile terminal 200 to perform a screen lock operation by simultaneously pressing the left frame pressure sensing unit 212, the right frame pressure sensing unit 213 and the upper frame pressure sensing unit 214.

In general, when the user no longer uses the mobile terminal, the mobile terminal maybe brought into a locked state through a certain operation to prevent the mobile terminal from being mis-operated in a dormant state. Therefore, according to the present disclosure, the user may complete screen locking for the mobile terminal 200 by simultaneously pressing the left frame pressure sensing unit 212, the right frame pressure sensing unit 213 and the upper frame pressure sensing unit 214 of the mobile terminal 200. Specifically, when the user holds the mobile terminal 200, the user may simultaneously touch the left side, the right side and the upper side of the frame of the mobile terminal 200 with the palms or fingers, so that the left frame pressure sensing unit 212, the right frame pressure sensing unit 213 and the upper frame pressure sensing unit 214 may simultaneously generate corresponding pressing signals, and the controller 220 (not shown in FIG. 4B) of the mobile terminal 200 may perform a screen lock operation for the mobile terminal 200 after sensing the pressing signals.

FIG. 4C illustrates another diagram of operations of the mobile terminal 200 according to the present disclosure. As shown in FIG. 4C, the pressure sensing units 211 may further comprise a lower frame pressure sensing unit 215, and the user may instruct the mobile terminal 200 to perform a home page return operation by simultaneously pressing the left frame pressure sensing unit 212, the right frame pressure sensing unit 213 and the lower frame pressure sensing unit 215.

Specifically, when the user holds the mobile terminal 200, the user may simultaneously touch the left side, the right side and the lower side of the frame of the mobile terminal 200 with the palms or fingers, so that the left frame pressure sensing unit 212, the right frame pressure sensing unit 213 and the lower frame pressure sensing unit 215 may simultaneously generate corresponding pressing signals, and the controller 220 (not shown in FIG. 4C) of the mobile terminal 200 may perform the home page return operation for the mobile terminal 200 after sensing the pressing signals.

In general, when the user holds the mobile terminal 200 with a single hand, it is difficult to simultaneously touch the left side, the right side and the lower side of the frame of the mobile terminal 200 through a palm or fingers. Therefore, as an example of the present disclosure, the user may simultaneously touch the left side and the right side of the frame of the mobile terminal 200 with the palm or fingers while simultaneously bringing the mobile terminal 200 into contact with a planar object, such as a desktop etc., and press down the mobile terminal 200, so that the left frame pressure sensing unit 212, the right frame pressure sensing unit 213 and the lower frame pressure sensing unit 215 may simultaneously generate corresponding pressing signals to instruct the mobile terminal 200 to perform the home page return operation.

FIG. 4D illustrates another diagram of operations of the mobile terminal 200 according to the present disclosure. According to the present disclosure, there may also be provided with a plurality of left frame pressure sensing units 212 or a plurality of right frame pressure sensing units 213 according to different specific locations. For example, the right frame pressure sensing units 213 are provided as a first right frame pressure sensing unit 2131, a second right frame pressure sensing unit 2132 and/or a third right frame pressure sensing unit 2133, the first right frame pressure sensing unit 2131 may be located at an upper portion of the right side of the frame of the mobile terminal 200, the second right frame pressure sensing unit 2132 may be located in the middle of the right side of the frame of the mobile terminal 200, and the third right frame pressure sensing unit 2133may be located at a lower portion of the right side of the frame of the mobile terminal 200.

The user may instruct the mobile terminal 200 to perform a corresponding operation by pressing the left frame pressure sensing unit 212 and any of the right frame pressure sensing units. Specifically, when the user holds the mobile terminal 200 with a single hand, the user may instruct the mobile terminal 200 to perform different operations through different locations where a thumb touches the right frame pressure sensing units 213.

For example, the user may instruct the mobile terminal 200 to perform a screen wake-up operation by pressing the left frame pressure sensing unit 212 and the first right frame pressure sensing unit 2131. The user may also instruct the mobile terminal 200 to perform a dialing operation by pressing the left frame pressure sensing unit 212 and the second right frame pressure sensing unit 2132. In addition, the user may instruct the mobile terminal 200 to perform a photographing operation by pressing the left frame pressure sensing unit 212 and the third right frame pressure sensing unit 2133. Of course, those skilled in the art may set functions corresponding to different pressing operations according to practical requirements, for example, instruct the mobile terminal 200 to perform a screen capture operation etc. by pressing the left frame pressure sensing unit 212 and the second right frame pressure sensing unit 2132, and the present disclosure is not limited thereto.

In the present disclosure, when the left frame pressure sensing unit 212 or the right frame pressure sensing unit 213 is subdivided into a plurality of units, for example, when the user performs a game operation using the mobile terminal 200, a game pad may be replaced with the pressure sensing units to perform a corresponding operation. FIG. 4E illustrates a diagram of operations of the mobile terminal 200 according to the present disclosure. In FIG. 4E, the user may instruct a character in an operated game to move to the right by pressing the upper frame pressure sensing unit 214 of the mobile terminal 200, instruct the character to move to the left by pressing the lower frame pressure sensing unit 215, and instruct the character to perform an operation such as acceleration or jumping etc. respectively by pressing the first right frame pressure sensing unit 2131 and the third right frame pressure sensing unit 2133.

FIG. 3D illustrates another diagram of connection of the pressure sensing units 211 according to the present disclosure. As shown in FIG. 3D, the right frame pressure sensing units 213 comprise a first right frame pressure sensing unit 2131, a second right frame pressure sensing unit 2132 and a third right frame pressure sensing unit 2133, and the first right frame pressure sensing unit 2131, the second right frame pressure sensing unit 2132 and the third right frame pressure sensing unit 2133 may be pressure sensors 2111.The first right frame pressure sensing unit 2131, the second right frame pressure sensing unit 2132 and the third right frame pressure sensing unit 2133 may be connected to the controller 220 respectively, so that the first right frame pressure sensing unit 2131, the second right frame pressure sensing unit 2132 and the third right frame pressure sensing unit 2133 may generate corresponding pressing signals and transmit the pressing signals to the controller 220 upon receiving a pressing operation to instruct the mobile terminal 200 to perform a corresponding operation.

FIG. 3E illustrates another diagram of connection of the pressure sensing units 211 according to the present disclosure. As shown in FIG. 3E, the right frame pressure sensing units 213 comprise a first right frame pressure sensing unit 2131, a second right frame pressure sensing unit 2132 and a third right frame pressure sensing unit 2133, and the first right frame pressure sensing unit 2131, the second right frame pressure sensing unit 2132 and/or the third right frame pressure sensing unit 2133 may be capacitor electrodes 2112. The first right frame pressure sensing unit 2131, the second right frame pressure sensing unit 2132 and the third right frame pressure sensing unit 2133 may be connected to the controller 220 respectively, so that the first right frame pressure sensing unit 2131, the second right frame pressure sensing unit 2132 and the third right frame pressure sensing unit 2133 may generate corresponding capacitance signals and transmit the capacitance signals to the controller 220 upon receiving a pressing operation to instruct the mobile terminal 200 to perform a corresponding operation.

It should be noted that, in the above examples, the right frame pressure sensing units 213 are taken as an example, and the right frame pressure sensing units 213 are subdivided into the first right frame pressure sensing unit 2131, the second right frame pressure sensing unit 2132 and the third right frame pressure sensing unit 2133. Those skilled in the art may set the left frame pressure sensing units 212 to comprise a first left frame pressure sensing unit, a second left frame pressure sensing unit and/or a third left frame pressure sensing unit in the same manner according to practical requirements, and the present disclosure is not limited to thereto.

In the embodiments of the present disclosure, with one or more pressure sensing units being provided on the frame of the mobile terminal, by pressing at least one of the one or more pressure sensing units by the user, pressing information associated with the pressed pressure sensing unit may be generated. The controller of the mobile terminal may instruct the mobile terminal to perform a corresponding operation after receiving the pressing signal. The present disclosure avoids the problem of setting more physical keys on the frame of the mobile terminal to complete many functional operations by setting the pressure sensing units without increasing the thickness and weight of the mobile terminal, which enhances the simplicity of the design of the mobile terminal and improves the convenience of carrying the mobile terminal by the user.

It will be appreciated by those skilled in the art that the embodiments of the present disclosure can be provided as methods, systems, or computer program products. Accordingly, the embodiments of the present disclosure may take a form of a pure hardware embodiment, a pure software embodiment, or a combination of software and hardware aspects. Moreover, the embodiments of the present disclosure may take a form of a computer program product implemented on one or more computer usable storage media (including but not limited to disk storage, CD-ROM, optical memory, etc.) in which computer usable program codes are included.

The embodiments of the present disclosure are described with reference to the flowcharts and/or block diagrams of the methods, terminal devices (systems) and computer program products according to the embodiments of the present disclosure. It should be understood that each flow and/or block in the flowcharts and/or block diagrams as well as a combination of the flows and/or blocks in the flowcharts and/or block diagrams can be implemented by computer program instructions. These computer program instructions can be provided to a processor of a general-purpose computer, a dedicated-purpose computer, an embedded processor, or processors of other programmable data processing terminal devices to generate a machine. Thereby, the instructions executed by the computer or the processors of other programmable data processing terminal devices generate means for implementing functions specified in one or more flows in the flowcharts and/or one or more blocks in the block diagrams.

These computer program instructions can also be stored in a computer readable memory capable of introducing the computer or other programmable data processing terminal devices to operate in a particular mode. Thereby, the instructions stored in the computer readable memory generate an article of manufacture comprising instruction means for implementing functions specified in one or more flows in the flowcharts and/or one or more blocks in the block diagrams.

These computer program instructions can also be loaded onto the computer or other programmable data processing terminal devices, so as to enable a series of operation steps to be performed on the computer or other programmable terminal devices to generate a computer-implemented process. Thereby, the instructions executed on the computer or other programmable terminal devices provide a step of implementing functions specified in one or more flows in the flowcharts and/or one or more blocks in the block diagrams.

While preferred embodiments of the embodiments of the present disclosure have been described, those skilled in the art can make further changes and modifications to these embodiments once the basic inventive concept is known. Accordingly, the appended claims are intended to be construed as including the preferred embodiments and all changes and modifications that fall within the scope of the embodiments of the present disclosure.

Finally, it should also be noted that, relational terms such as first and second herein are used only to distinguish an entity or operation from another entity or operation without necessarily requiring or implying that there is any such practical relationship or sequence between these entities or operations. Further, terms “comprising”, “including” or any other variant thereof are intended to encompass a non-exclusive inclusion so that processes, methods, articles or terminal devices including a series of elements include not only those elements but also other elements that are not explicitly listed, or elements that are inherent to such processes, methods, articles, or terminal devices. In the absence of more restrictions, the elements defined by the statement “including a . . . ” do not exclude the presence of additional identical elements in the processes, methods, articles, or terminal devices that include the elements.

The mobile terminal according to the present disclosure has been described in detail above. The principles and implementations of the present disclosure have been set forth herein using specific examples, and the description of the above embodiments is only intended to facilitate understanding of the methods according to the present disclosure and core ideas thereof. At the same time, it will be understood by those skilled in the art that there may be changes to the detailed description and application scope according to the idea of the present disclosure, and therefore the present specification is not to be construed as limiting the present disclosure.

1. A mobile terminal, comprising:
a frame, wherein one or more pressure sensing units are provided inside the frame,
wherein the one or more pressure sensing units are configured to, when at least one of the one or more pressure sensing units is pressed, instruct the mobile terminal to perform an operation associated with the pressed pressure sensing unit;
wherein the pressure sensing units comprises capacitor electrodes, wherein each of the capacitor electrodes is connected to the controller and configured to, in response to being pressed, generate a capacitance signal according, to a variation of a distance between the capacitor electrode and a part of the frame the capacitor electrode located, and transmit the capacitance signal to the controller.

2. The mobile terminal according to claim 1, wherein the pressure sensing units comprises a left frame pressure sensing unit and a right frame pressure sensing unit, and the mobile terminal is instructed to perform an unlock operation by pressing the left frame pressure sensing unit and the right frame pressure sensing unit.

3. The mobile terminal according to claim 2, wherein the pressure sensing units further comprise an upper frame pressure sensing unit, and the mobile terminal is instructed to perform a lock screen operation by simultaneously pressing the left frame pressure sensing unit, the right frame pressure sensing unit and the upper frame pressure sensing unit.

4. The mobile terminal according to claim 2, wherein the pressure sensing units further comprise a lower frame pressure sensing unit, and the mobile terminal is instructed to perform a home page return operation by simultaneously pressing the left frame pressure sensing unit, the right frame pressure sensing unit and the lower frame pressure sensing unit.

5. The mobile terminal according to claim 1, wherein the pressure sensing units comprise a left frame pressure sensing unit and right frame pressure sensing units which comprise a first right frame pressure sensing unit, a second right frame pressure sensing unit and/or a third right frame pressure sensing unit, and the mobile terminal is instructed to perform a corresponding operation by pressing the left frame pressure sensing unit and any of the right frame pressure sensing units.

6. The mobile terminal according to claim 5, wherein the mobile terminal is instructed to perform a screen wake-up operation by pressing the left frame pressure sensing unit and the first right frame pressure sensing unit.

7. The mobile terminal according to claim 5, wherein the mobile terminal is instructed to perform a dialing operation by pressing the left frame pressure sensing unit and the second right frame pressure sensing unit.

8. The mobile terminal according to claim 5, wherein the mobile terminal is instructed to perform a photographing operation by pressing the left frame pressure sensing unit and the third right frame pressure sensing unit.

9. The mobile terminal according to claim 1, further comprising a controller,
Wherein the pressure sensing units further comprise pressure sensors, wherein each of the pressure sensors is connected to the controller and configured to, upon receiving a pressing operation, generate a corresponding pressing signal and transmit the pressing signal to the controller.

10. (canceled)

11. (canceled)

12. (canceled)

13. (canceled)

14. (canceled)

15. (canceled)

16. (canceled)

17. (canceled)

18. (canceled)

19. (canceled)

20. (canceled)
